(19) United States
(12) Patent Application Publication
(10) Pub. No.: US 2012/0229539 A1
(43) Pub. Date: Sep. 13, 2012

(54) PRINTER AND CONTROL METHOD THEREOF

(75) Inventor: Shinichi Arazaki, Fujimi-machi (JP)

(73) Assignee: SEIKO EPSON CORPORATION, Tokyo (JP)

(21) Appl. No.: 13/416,430

(22) Filed: Mar. 9, 2012

(30) Foreign Application Priority Data
Mar. 9, 2011 (JP) 2011-051326

(51) Int. Cl. B41J 29/38

(52) U.S. Cl. 347/9

(57) ABSTRACT

A printing head in which a plurality of nozzles is formed is moved in a predetermined direction, and is caused to execute main scanning in which the ink is ejected from the plurality of nozzles, in which the printing head performs printing another line in Nth main scanning between lines which are printed in the N-1th main scanning or prior thereto, performs printing a unit of printing which is configured by a plurality of lines in Nmax main scannings, and controls an amount of ink which is ejected from the printing head so that the ejecting amount of ink may be controlled so that the amount of ink ejected in Nmax-th main scanning is larger than that in the main scanning of Nmax-1th time or prior thereto, even if data items denoting the amount of ink for each pixel are the same as each other.

### BACKGROUND

1. Technical Field

The present invention relates to a printer.

2. Related Art

In an ink jet printer, printing is performed with respect to a plurality of lines on a printing medium by performing main scanning in which ink is ejected while moving a printing head having a plurality of nozzles to a predetermined direction, performing sub-scanning in which the printing head is moved in a direction perpendicular to the above described predetermined direction, after completing the printing on the plurality of lines, and by repeating the main scanning and the sub-scanning. In addition, since it is possible to execute the printing at a high resolution by printing dots at a shorter gap than the nozzle gap, a technology of printing a line in Nth main scanning between lines which are printed in the N-1th main scanning (for example, refer to JP-A-2002-292908).

In the technology in JP-A-2002-292908, it was difficult to prevent a deviation of a formation position of lines between a line which is printed at an earlier timing and a line which is printed at a later timing. That is, in the ink jet printer, since the printing medium is easily extended due to a penetration of ink into the printing medium when the ink is printed on the printing medium, when a plurality of lines are printed by the main scanning plural times, a large amount of ink is already printed on the printing medium in a stage of performing the last main scanning. Accordingly, in the stage of performing the last main scanning, the printing medium is further extended than in preceding stages of the main scanning, therefore, the formation position of lines in the previous stage of the last main scanning and the formation position of lines in the last main scanning are deviated from each other. The occurrence of deviation is significant when the print head is large, and the number of nozzles which are formed on the printing head is large. Accordingly, in a printer which includes a printing head with a size in which it is possible to perform the printing from one end to another on one side of the printing medium, particularly, the above described deviation occurs significantly.

### SUMMARY

An advantage of some aspects of the invention is to provide a technology in which a deviation of the formation position of lines which is caused by a timing difference in main scanning can be suppressed.

In the invention, printing is performed by controlling the amount of ink ejected from the printing head such that the amount of ink ejected in Nmax main scannings is larger than that in the main scanning of Nmax-1th time and prior thereto, even when data items denoting the amount of ink are the same as each other for each pixel. That is, an image is formed by printing another line in Nth main scanning between lines which are printed in the N-1th main scanning, and in a printing method in which a unit of printing which is configured by a plurality of lines is printed in the Nmax main scannings, it is configured such that the amount of ink in the main scanning prior to the last (Nmax times) main scanning is relatively small.

According to the configuration, in the main scanning to be executed in order to complete printing of the plurality of lines which configures the unit of printing, the amount of ink in main scanning which is earlier than the Nmax-th main scanning becomes relatively small, the extension of the printing medium due to the ink printed in the main scanning which is earlier than the Nmax-th main scanning becomes small compared to a case where the amount of ink is the same as each other in each main scanning, and it is possible to suppress the deviation in the formation position of lines due to the different timing of the main scanning.

A plurality of nozzles is formed in the printing head, and due to this, a plurality of lines may be printed in the main scanning at the same time. A printing head control unit may be able to execute the main scanning and sub-scanning by controlling an operation of the printing head. The main scanning and sub-scanning are operations in which the printing head and the printing medium move relatively, and in the main scanning, the relative movement direction of the printing head and the printing medium is set to be a predetermined direction in a state where ink ejection from the plurality of nozzles is involved. In the sub-scanning direction, the relative movement direction of the printing head and the printing medium is set to be perpendicular to the predetermined direction.

The printing head control unit may be able to print an image which is related to a printing instruction while making the order of the main scanning and the ink amount which is ejected in each main scanning be related to each other. That is, the image is formed by printing another line in the Nth main scanning between lines which are printed in the N-1th main scanning or prior thereto, and in a configuration in which the unit of printing which is configured by the plurality of lines is printed in the Nmax main scannings, the printing of the unit of printing is completed by further forming a line between the printed lines. In this case, the order of printing each line in the printer according to the order of the main scanning is specified, by performing the main scanning in a predetermined order in order to complete the printing in the unit of printing. Therefore, even if data which denotes the amount of ink of each pixel is the same as each other, the ejected amount of ink is controlled so that the amount of ink in the Nmax-1th main scanning or prior thereto which is earlier than the Nmax-th main scanning is relatively small compared to the amount of ink in the Nmax-th main scanning.

Here, data which denotes the amount of ink for each pixel may be data for specifying the amount of ink directly or indirectly, may be data for specifying whether or not ejecting ink droplets for each pixel may be gradation values for denoting the amount of ink for each pixel, or may be gradation values of another color system (for example, an input color system of sRGB, or the like) which corresponds to the amount of ink for each pixel.

In addition, M nozzles are arranged in one row in the sub-scanning direction on the printing head, and L×M lines configure the unit of printing when L lines are printed using the Nmax-th main scanning. In addition, the order of performing the Nmax-th main scanning may be determined before starting the printing, the main scanning may be performed so that the adjacent plurality of lines is printed according to an arrangement order of the line, and the main scanning may be performed so as to print in an order different from the arrangement order of lines (an order of printing a line which is separated from the printed line by one or more lines). It is possible to adopt a variety of configurations.

Further, in the printer, even if data items denoting the amount of ink for each pixel are the same as each other, the ejecting amount of ink may be controlled so that the amount of ink ejected in Nmax main scannings is larger than that in the main scanning of Nmax-1th time or prior thereto. In addition, when there is a range of values in data denoting the amount of ink for each pixel, even if the data items denoting the amount of ink for each pixel are the same as each other in at least a part of the range of values, it is possible to configure so that the amount of ink which is ejected in the Nmax-th main scanning and the amount of ink which is ejected in the Nmax-1th main scanning or prior thereto are different from each other. Naturally, it may be configured such that the amount of ink which is ejected in the Nmax-th main scanning and the amount of ink which is ejected in the Nmax-1th main scanning or prior thereto are different from each other, even if the data items denoting the amount of ink for each pixel are the same as each other in every part of the range of values.

In addition, here, the amount of ink which is ejected in at least the Nmax-th main scanning may be larger than the ink ejected in the Nmax-1th main scanning or prior thereto. Naturally, it may be configured such that the amount of ink increases linearly or nonlinearly every time the number of main scannings increases, in the Nmax-1th main scanning or prior thereto. Further, the amount of ink may be adjusted by a recording density of ink per unit area, and may be adjusted according to the size of the ink droplets. Accordingly, it is possible to adopt a variety of methods of adjusting.

In addition, as a configuration example for adjusting the amount of ink for every main scanning, by adjusting the recording density per unit area, it is possible to control the printing head such that the recording density of the ink which is printed on the printing medium in the Nmax-th main scanning is increased compared to the Nmax-1th main scanning or prior thereto, even if the data items denoting the amount of ink for each pixel are the same as each other. As a configuration for varying the recording density on the printing medium, a variety of configurations may be adopted, and for example, the recording density of ink may be adjusted by changing the printing resolution in the main scanning direction according to the number of main scannings, and increasing the number of ink droplets which is recorded on the printing medium according to the same gradation values.

As a configuration for changing the printing resolution in the main scanning direction according to the number of main scannings, it is possible to adopt a variety of configurations, and for example, a configuration may be adopted in which the number of ink droplets which is ejected per line is increased or decreased, by increasing or decreasing a unit distance, in the main scanning in which the ink droplet is ejected every time the printing head is moved in the unit distance.

In addition, as a configuration in which the amount of ink for each main scanning is adjusted by the size of the ink droplet, it is possible to control the printing head such that the size of the ink droplets which are ejected from the plurality of nozzles in the Nmax-th main scanning is larger than that in the Nmax-1th main scanning or prior thereto, even if data items denoting the amount of ink for each pixel are the same as each other. As a configuration for varying the size of the ink droplet, for example, it is possible to vary the magnitude of a voltage which is applied to an element (for example, a piezo element or a resistance element) for controlling ejection of the ink droplets in the nozzle which ejects ink droplets. It is needless to say that the size of the ink droplets may be changed by varying a waveform of the voltage.

Further, as in the invention, when the unit of printing which is configured by the plurality of lines is printed in the Nmax main scannings, it is possible to apply the method in which the amount of ink is controlled so that the amount of ink which is ejected on the basis of the same gradation values in the Nmax-th main scanning becomes larger than in the main scanning which has been performed earlier may be also applied as a program, or a method. In addition, the above described device, program, and method can be executed as a single device, or can be executed by using shared components in a device with complex functionality, accordingly, a variety of aspects can be included thereto.

### BRIEF DESCRIPTION OF THE DRAWINGS

The invention will be described with reference to the accompanying drawings, wherein like numbers reference like elements.

FIG. 1 is a block diagram of a printer according to an embodiment of the invention.

FIGS. 2A and 2B are diagrams which show schematic configurations of the printer, FIG. 2C is a diagram of a schematic configuration of a printing head, and FIG. 2D is a diagram which shows pixels which are printed on a printing medium.

FIG. 3 is a flowchart of printing control processing.

FIG. 4 is a flowchart of printing control processing.

### DESCRIPTION OF EXEMPLARY EMBODIMENTS

Here, embodiments of the invention will be described according to a following order.
1. Configuration of printer:
2. Printing control processing:
3. Another embodiment:

### 1. Configuration of Printer

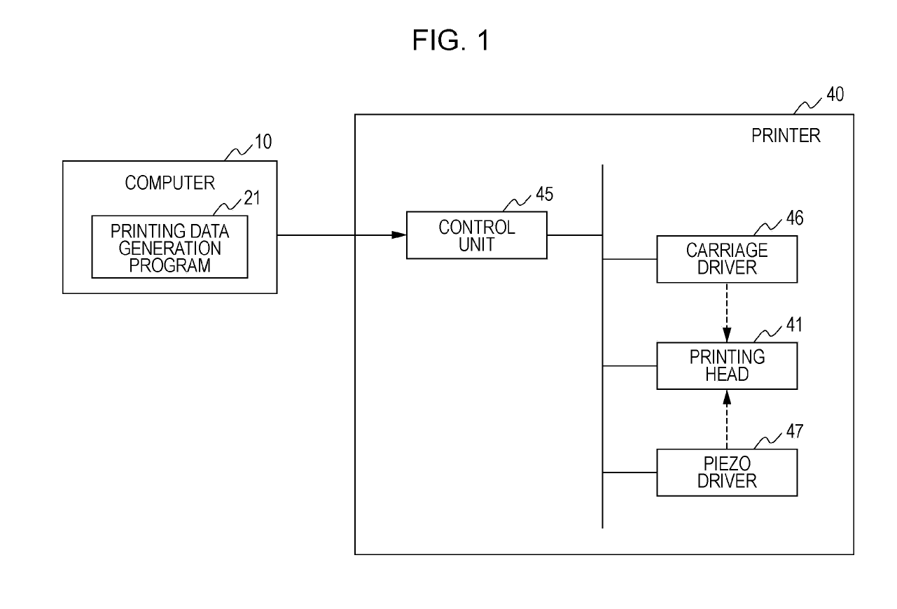

FIG. 1 is a block diagram which shows a configuration of a printer control system according to the invention. A printer 40 includes a control unit 45 having a ROM, a ROM, a CPU or the like, a carriage driver 46, a piezo driver 47, and a printing head 41, and it is possible to execute a program which is recorded in the RAM in the control unit 45. According to the embodiment, as one of the programs, it is possible to obtain printing data which is generated by a printing data generation program 21 of a computer 10, and to execute a function of performing printing on the basis of the printing data. The function of performing the printing includes a function of executing the printing while suppressing a deviation of a formation position of lines by preventing an extension of a printing medium.

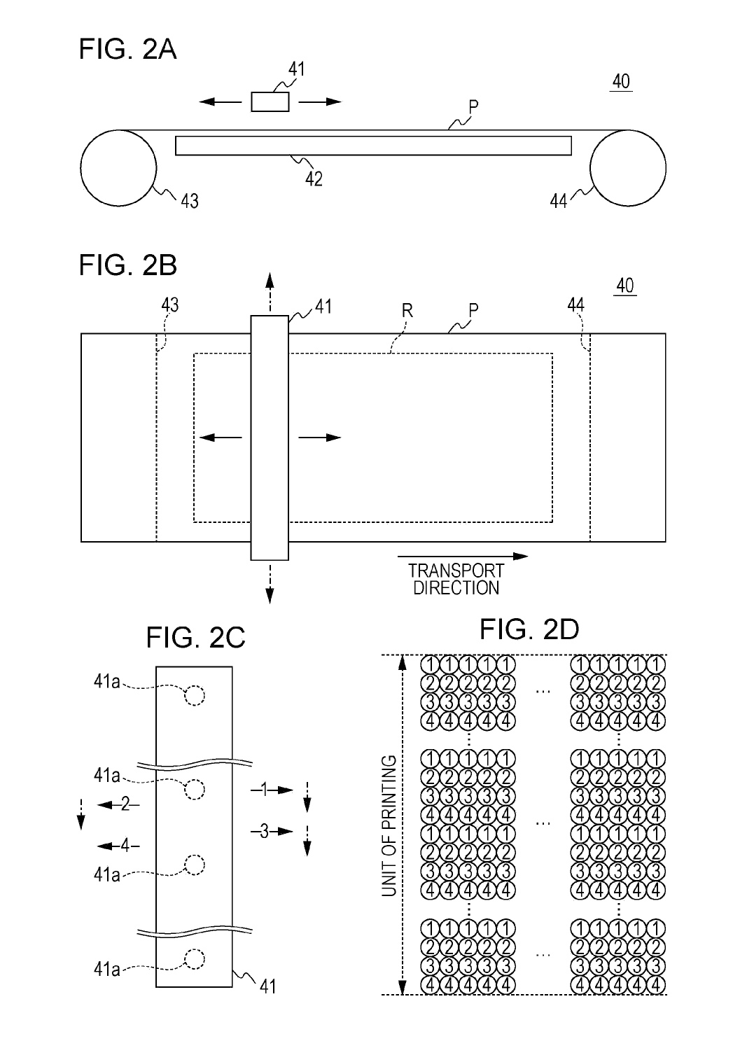

FIGS. 2A and 2B are a side view and a top view, respectively, which show a schematic configuration of the printer 40. According to the embodiment, the printer 40 includes two roll units 43 and 44, accumulates a printing medium P on one roll unit 43, and is able to transport the printing medium P on a platen 42 by winding the printing medium using another roll unit 44. The printing head 41 is provided on the upper part of the platen 42, and the printing head 41 is able to move in directions parallel (arrow directions of solid lines shown in FIGS. 2A and 2B) and perpendicular (arrow directions of dashed lines shown in FIG. 2B) to the transport direction of the printing medium P in a parallel plane with respect to the printing medium P on the platen 42.

In addition, a plurality of nozzles is formed in the printing head 41, and ink droplets can be ejected from each nozzle. FIG. 2C is a diagram which schematically shows a top view of the printing head 41, and schematically shows nozzles 41a which are open on a bottom surface of the printing head 41, using dashed lines. In the printing head 41, as shown in FIG. 2C, a plurality of nozzles 41a is formed along a direction in which the printing head 41 extends. The plurality of nozzles 41a is an opening portion of an ink chamber which is connected to an ink tank, a wall face of the ink chamber is configured so as to be able to move according to the extension and contraction of a piezo element, the volume of the ink chamber fluctuates along with the fluctuation in the wall face of the ink chamber, thereby ejecting ink in the ink chamber from the nozzle. The plurality of piezo elements corresponding to the plurality of nozzles 41a is connected with the piezo driver 47 shown in FIG. 1.

The piezo driver 47 is able to apply a voltage with a predetermined waveform to the plurality of piezo elements. According to the embodiment, it is possible to eject ink droplets of three different sizes from the same nozzle, by applying the piezo element by selecting a waveform of the voltage to be applied among the predetermined waveforms. In addition, the control unit 45 is able to give an instruction of ejecting ink droplets of a desired size from an arbitrary nozzle at an arbitrary timing, by outputting a control signal to the piezo driver 47.

In addition, according to the embodiment, the printing head 41 is configured so as to be able to move in at least two directions by a carriage which is not shown. That is, the carriage is able to move the printing head 41 by a unit distance in a direction perpendicular (arrow directions of solid lines shown in FIGS. 2A and 2B) to a direction in which the nozzles 41a are aligned on the printing head 41 by the control of the carriage driver 46. In addition, when the printing head 41 reaches an end portion of a range in which the printing head 41 is movable in a direction perpendicular to a direction in which the nozzles 41a are aligned, the carriage is able to move the printing head 41 by the unit distance in a direction parallel to the direction (arrow directions of dashed lines shown in FIG. 2B) in which the nozzles 41a are aligned by a control of the carriage driver 46.

In addition, the movement direction, or the amount of movement of the printing head 41 by the carriage driver 46 is specified by a control signal to the carriage driver 46 which is output by the control unit 45. According to the embodiment, the control unit 45 moves the printing head 41 by the unit distance in a direction perpendicular to the direction in which the nozzles 41a are aligned, by outputting a control signal with respect to the carriage driver 46, and ejects ink from the nozzles 41a by outputting a control signal to the piezo driver 47, every time the printing head moves by the unit distance. In the present specification, an operation of moving the printing head 41 in a direction perpendicular with respect to the direction in which the nozzles 41a are aligned is referred to as the main scanning. In addition, an operation of moving the printing head 41 in a direction parallel to the direction in which the nozzles 41a are aligned is referred to as the sub-scanning.

The full length of the printing head 41 (the length in a direction perpendicular to the transport direction of the printing medium P) of the printer 40 according to the embodiment is longer than the full width of the printing medium P (the width in a direction perpendicular to the transport direction of the printing medium P) as shown in FIG. 2B, and it is possible to print the ink in a rectangular printing range R which is shown by a dashed line, by repeating the above described main scanning and sub-scanning. In addition, it is possible to obtain a printed matter with a resolution of four times the pitch of the nozzles 41a in the sub-scanning direction, by setting the distance when causing the printing head 41 to perform the sub-scanning to the distance of ¼ of the gap of the nozzles 41a.

As described above, in the printer 40 according to the embodiment, it is possible to print the ink on the printing medium P every time the printing head 41 is moved by the unit distance in the main scanning direction, and to print a plurality of pixels in the main scanning direction. In addition, the plurality of nozzles 41a is aligned in the printing head 41, and since the printing head 41 can move in the sub-scanning direction, it is possible to print the plurality of pixels in the sub-scanning direction, as well. According to the embodiment, the plurality of pixels which is aligned in the main scanning direction on the printing medium P is referred to as lines. In addition, even in image data to be described later which shows an image printed on the printing medium P, the plurality of pixels aligned in the same direction as the lines on the printing medium P are referred to as lines.

FIG. 2D schematically shows pixels on the printing medium P using circles, each line is configured by the plurality of pixels which is aligned in the horizontal direction, and the plurality of lines is aligned in the vertical direction. According to the embodiment, it is possible to obtain a printed matter with a resolution of four times the pitch of the nozzle 41a in the sub-scanning direction, by setting the distance when causing the printing head 41 to perform the sub-scanning to a distance of ¼ of the gap of the nozzle 41a, as described above. In FIG. 2D, the order of the main scanning is exemplified when obtaining the printed matter with the resolution of four times the pitch of the nozzle 41a in the sub-scanning direction. That is, FIG. 2D shows the order of the main scanning by the number in the circle, and in the drawing, it shows an example in which the printing is performed from the lines at the upper part.

The example shown in FIG. 2D is an example of a printing operation in which an image is formed by printing another line in the Nth main scanning between lines which are printed in the main scanning of N-1th (N is a natural number of 2 or more), or prior thereto, and a unit of printing which is configured by the plurality of lines is printed in the Nmax main scannings (Nmax is the maximum value of N). That is, in the example shown in FIG. 2D, a line denoted by circles with number 2 is printed as another line in the second main scanning between lines which are denoted by circles with number 1, and are printed in the first main scanning, a line denoted by circles with number 3 is printed as another line in the third main scanning between a line which is denoted by circles with number 1, and is printed before the second main scanning and a line denoted by circles with number 2, and a line denoted by circles with number 4 is printed as another line in the fourth main scanning between a line which is denoted by circles with number 3, and is printed before the third main scanning and a line denoted by circles with number 1. In addition, since the lines in the sub-scanning direction are filled without a gap by performing the main scanning four times in each nozzle, when the number of nozzles is M, a printing unit which is configured by 4×M lines is printed in four main scannings. In this printing, for example, the main scanning is performed in the order of numbers attached to the arrow of solid line in the printing head 41 shown in FIG. 2C, the sub-scanning which is denoted by a one dot dashed line is performed, after completing each main scanning, thereby executing the printing.

### 2. Printing Control Processing

Subsequently, printing control processing when executing printing using the above described printer 40 will be described. According to the embodiment, the printer 40 prints an image when printing data for printing the image which is denoted by image data is generated in the computer 10, and is transmitted to the printer 40. That is, the computer 10 is able to execute a printing data generation program 21 in a control unit which is not shown, and the computer 10 generates the printing data by executing an adjustment of the number of pixels, color conversion processing, half-toning processing, and rearranging processing on the basis of the image data, using the processing of the printing data generation program 21, and transfers the printing data to the printer 40.

Specifically, when a user gives an instruction of executing printing by designating an image as a printing target using a user interface which is not shown, the computer 10 obtains image data and a printing resolution relating to the instruction of executing printing, by the processing of the printing data generation program 21, and adjusts the number of pixels of the image data so as to be printed with the printing resolution. According to the embodiment, the number of pixels is adjusted so as to be at least a resolution of four times the pitch of the nozzle 41a in the sub-scanning direction.

Subsequently, the computer 10 executes the color conversion processing in which an input color system as a color system of the image data is converted to an output color system which corresponds to a color of ink which can be ejected from the printer 40, using the processing of the printing data generation program 21. Specifically, the image data according to the embodiment is data of sRGB color system in which colors of each pixel are expressed by a combination of a gradation value of each color component of RGB. Accordingly, the input color system is the sRGB color system. In addition, in the printer 40, it is possible to eject ink of CMYK, and to express colors of each pixel on the printing medium P by a combination of gradation value of each color component of CMYK. Accordingly, the output color system is the CMYK color system. Therefore, the computer 10 refers to the color conversion table which is predefined, and converts the color system of each pixel of the image data from the sRGB color system to the CMYK color system, by performing an interpolation operation or the like (converts RGB gradation value to the CMYK gradation value).

Subsequently, the computer 10 executes half-toning processing by the processing of printing data generation program 21. That is, the computer 10 detects the presence or absence of ejection of the ink droplets, and generates data which designates the size of the ink droplets for each pixel when the ink droplets are ejected, on the basis of the CMYK gradation value after the above described color conversion. Subsequently, the computer 10 performs the rearranging processing for rearranging the data after the half-toning processing, by the processing of printing data generation program 21. That is, the computer 10 rearranges the order of the above described data so that the pixel which is obtained by printing the ink in each main scanning is to be arranged in an earlier order. In addition, the computer 10 generates the printing data so that the data for each pixel is transmitted to the printer 40 in the order after the rearrangement, and transfers the printing data to the printer 40 by attaching data denoting the printing resolution. As a result, data in which the ink droplets of pixels with number 1 in the circle in FIG. 2D are aligned in the order of being printed in the first main scanning is transmitted to the printer 40, and subsequently, data in which the ink droplets of pixels with number 2 in the circle in FIG. 2D are aligned in the order of being printed in the second main scanning, data in which the ink droplets of pixels with number 3 in the circle in FIG. 2D are aligned in the order of being printed in the third main scanning, and data in which the ink droplets of pixels with number 4 in the circle in FIG. 2D are aligned in the order of being printed in the fourth main scanning are transmitted to the printer 40.

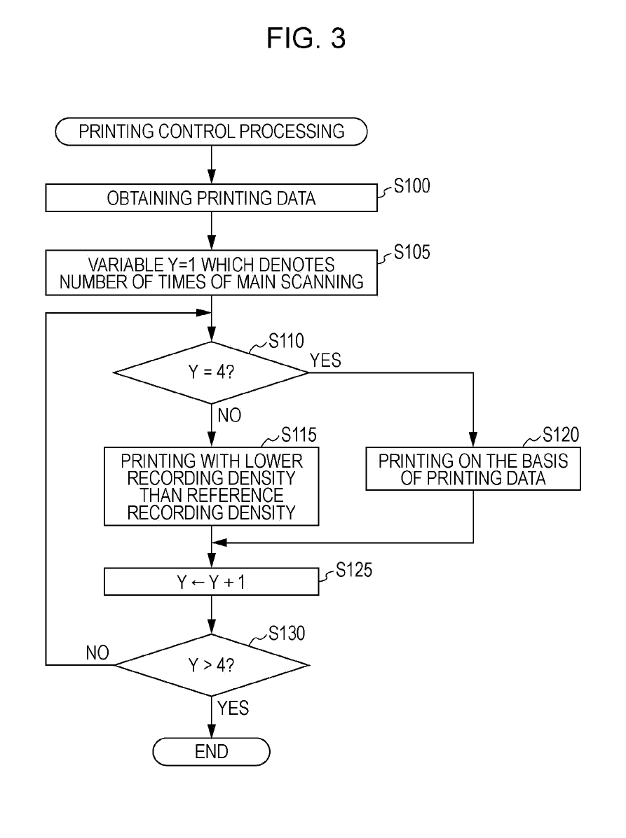

When the printing data is transmitted to the printer 40, the printer 40 executes the printing control processing shown in FIG. 3. In the printing control processing, the control unit 45 first obtains the printing data (step S100). That is, the printing data which is transmitted from the computer 10 is obtained, and is sequentially recorded in a memory which is not shown.

Subsequently, the control unit 45 initializes a variable Y which denotes the number of main scannings to 1 (step S105), and determines whether or not the variable Y is equal to 4 (step S110). That is, according to the embodiment, as shown in FIG. 2D, it has a configuration in which 4×M printing units are printed using M nozzles, by performing printing of 4 lines in four main scannings by printing the lines in order from the top, and determines which main scanning is the target of the execution among the four times main scanning.

In addition, in step S110, when it is determined that the variable Y is not equal to 4, the control unit 45 determines that the main scanning as the target of the execution is any one of the first to third main scanning, and performs printing using the Yth main scanning with a lower density than the reference recording density (step S115). On the other hand, in step S110, when it is determined that the variable Y is equal to 4, the control unit 45 determines that the main scanning as the target of execution is the fourth main scanning, and performs printing by the fourth main scanning on the basis of the printing data (step S120).

According to the embodiment, the printer 40 specifies a printing resolution which is instructed by a user on the basis of the printing data, and executes the printing with the printing resolution. That is, the control unit 45 outputs a control signal for moving the printing head 41 in the main scanning direction by the unit distance which is equal to the pitch of the pixel in the printing resolution to the carriage driver 46. As a result, the printing head 41 performs the main scanning in a state where the printing of dots is possible with the printing resolution which is instructed by the user.

With this configuration, if the ink droplets are ejected on the basis of the printing data whenever the printing head 41 is moved by the unit distance, it is possible to perform the printing according to the printing data. However, according to the embodiment, in step S115, the control unit 45 performs thinning so as to make the printing density lower than the recording density (reference recording density) when the ink is printed according to the printing data. That is, the control unit 45 usually has a configuration in which, when the printing data denotes ejecting of any size of the ink droplets, a control signal for ejecting ink droplets with the size is output to the piezo driver 47, in order to perform printing of each pixel which is aligned in the main scanning direction. However, the control unit 45 has a configuration in which a control signal for ejecting the ink droplets is not output to the piezo driver 47, without depending on the printing data at a rate of one pixel per n pixels (n is a natural number of two or more). With this configuration, the pixel is subject to thinning at a rate of one pixel per n pixels, and printing with lower density than the reference recording density is performed in the first to third main scanning.

On the other hand, ink is printed according to the printing data in step S120. That is, when the printing data denotes ejecting ink droplets of any size, in order to perform printing of each pixel in the main scanning direction, the control unit 45 outputs a control signal for ejecting the ink droplets with the size to the piezo driver 47. According to the above described configuration, the printing head is controlled so that the recording density of the ink to be printed on the printing medium is increased in the fourth main scanning compared to the first to third main scanning, even if data items denoting the amount of ink for each pixel are the same as each other.

When the printing is performed in the above described step S115, or S120, the control unit 45 performs an increment of the variable Y (step S125), and determines whether or not the value of the variable Y is larger than the maximum value 4 (step S130). In addition, in step S130, processing after step S110 is repeated until the value of the variable Y is larger than the maximum value 4. According to the above described processing, it is possible to perform the printing so that the amount of ink which is ejected on the basis of the same gradation value of the image data becomes large in the fourth main scanning, compared to the first to third main scanning, even if data items denoting the amount of ink for each pixel are the same as each other.

According to the above described processing, the occurrence of extension due to penetrating of ink with respect to the printing medium P is suppressed according to the delayed timing of the main scanning such as the first to fourth main scanning, and it is possible to suppress the deviation of the formation position of lines which is caused by the different timing of the main scanning.

### 3. Another Embodiment

The above described embodiment is an example for performing the invention, and a variety of other embodiments can be adopted, as long as it is possible to control the amount of ink so that the amount of ink which is ejected on the basis of the same gradation value becomes large in the Nmax-th main scanning compared to the main scanning prior thereto, when the unit of printing which is configured by the plurality of lines is printed in the Nmax main scannings. For example, the printing data may be generated in the printer 40.

In addition, in the above described embodiment, a configuration was adopted in which printing is performed with lower recording density than the reference recording density by performing thinning before the Nmax-1th main scanning (first to third main scanning), however, the configuration of performing the printing with lower recording density than the reference recording density can adopt a variety of configuration other than that. For example, the thinning is performed prior to the Nmax-1th main scanning (first to third main scanning), and in the Nmax-th main scanning (fourth main scanning), it may be configured such that ink is ejected even in a pixel for which the printing data indicates that ink is not ejected.

Further, the recording density of the ink may be adjusted by changing the printing resolution in the main scanning direction for every main scanning, and increasing or decreasing the number of ink droplets which is recorded in the recording medium according to the same gradation value. For example, it may be configured such that the printing in the Nmax-th main scanning is performed with the printing resolution designated by the printing data, the printing is performed with a lower resolution than the designated printing resolution, in the Nmax-1th main scanning, and the number of ink droplets is decreased to be smaller than the number which is instructed in the printing data.

In addition, it may be configured such that when a certain printing resolution is designated by the printing data, in the Nmax-th main scanning, the printing is performed with a higher resolution than the designated printing resolution, the number of ink droplets is increased to be larger than the number which is instructed in the printing data along with the change in the printing resolution, and in the Nmax-1th main scanning, the printing is performed with a lower resolution than the designated printing resolution, and the number of ink droplets is decreased to be smaller than the number which is instructed in the printing data along with the change in the printing resolution. Further, here, it is preferable that the number of ink droplets be adjusted so as to suppress the fluctuation of color of image due to the increase or decrease in the number of ink droplets.

In addition, as a configuration for changing the printing resolution in the main scanning direction for every main scanning, a variety of configurations may be adopted, and for example, it may be possible to adopt a configuration in which the number of ink droplets which is ejected per line can be increased or decreased, by increasing or decreasing the unit distance, in the main scanning in which the ink droplets are ejected every time the printing head is moved by the unit distance. Further, the moving speed of the printing head may be maintained, or may be increased or decreased. When the moving speed of the printing head is maintained, the interval of ejecting ink (driving frequency when driving an element for ejecting ink droplets) is changed. When the moving speed of the printing head is changed, the interval of ink ejection is adjusted according to the moving speed, as necessary.

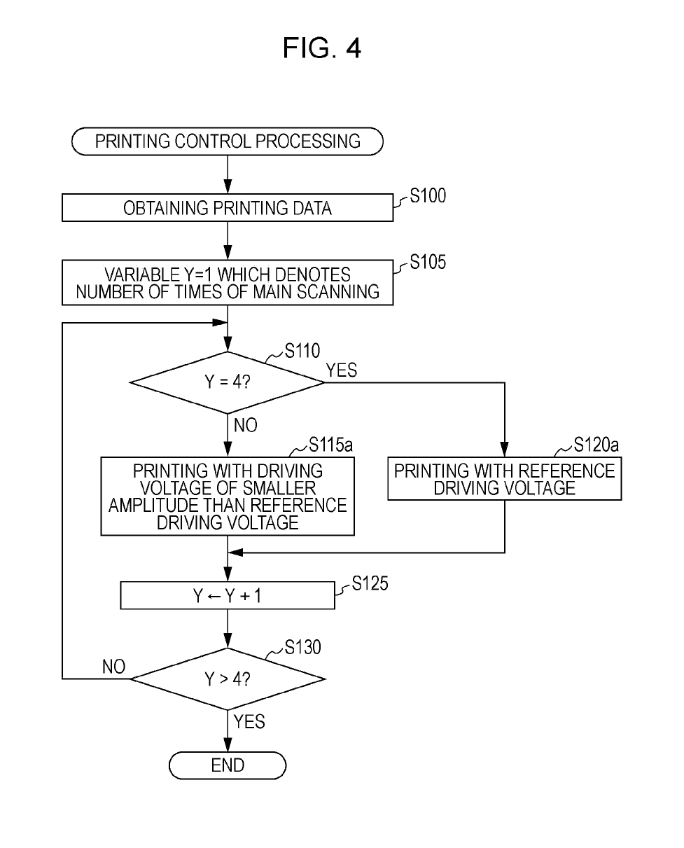

In addition, it may be configured such that the amount of ink is adjusted for every main scanning according to the size of the ink droplets. FIG. 4 is a flowchart which shows the printing control processing when the amount of ink is adjusted for every main scanning according to the size of the ink droplets. The printing control processing is executed in the printer 40 shown in FIG. 1, and includes the same processing as that in the printing control processing shown in FIG. 3. In the printing control processing shown in FIG. 4, the same processing as that in the printing control processing shown in FIG. 3 is denoted by the same reference numerals. In the printing control processing shown in FIG. 4, the steps S115 and S120a as the printing processing which is executed according to the number of main scannings are different from the printing control processing shown in FIG. 3.

Specifically, the piezo driver 47 in the example is able to output two types of driving voltage as driving voltages for ejecting ink droplets of multiple steps from each nozzle. For example, a reference driving voltage which ejects three types of respective ink droplets (large, medium, and small) of the reference amount of ink, and a driving voltage which ejects three types of respective ink droplets from nozzles by suppressing the amount of ink to be smaller than the reference amount of ink, and which has a smaller amplitude than the reference driving voltage are defined in advance. In addition, the piezo driver 47 is able to apply a driving voltage on the basis of a control signal output from the control unit 45 to the nozzle 41a, by selecting any one of the reference driving voltage and a driving voltage with smaller amplitude than the reference driving voltage.

Therefore, the control unit 45 performs printing by driving a piezo element using a driving voltage with smaller amplitude than the reference driving voltage, in step S115a. That is, the control unit 45 performs the printing by outputting a control signal to the piezo driver 47 so as to drive the piezo element using the driving voltage with smaller amplitude than the reference driving voltage. In addition, the control unit 45 performs the printing by driving the piezo element using the reference driving voltage in step S120a. That is, the control unit 45 performs the printing by outputting a control signal to the piezo driver 47 so as to drive the piezo element using the reference driving voltage.

According to the above described processing, it is possible to control the printing head so that the size of the ink droplets which are ejected from the plurality of nozzles in the fourth main scanning is larger than that in the first to third main scanning, even if data items denoting the amount of ink for each pixel are the same as each other. In addition, it is possible to adopt a variety of configurations as a configuration for changing the size of the ink droplets, for example, it is possible to change the size of the ink droplets by changing the waveform of the driving voltage.

What is claimed is:

1. A printer comprising:
a printing head in which a plurality of nozzles is formed; and
a printing head control unit which causes the printing head to execute main scanning in which the printing head is moved in a predetermined direction, and ink is ejected from the plurality of nozzles, and sub-scanning in which the printing head is moved in a direction perpendicular to the predetermined direction,
wherein the printing head control unit performs printing another line in Nth main scanning between lines which are printed prior to the N-1th main scanning (N is a natural number of two or more) or prior thereto, performs printing a unit of printing which is configured by a plurality of lines in Nmax main scannings (Nmax is the maximum value of N), and controls an amount of ink which is ejected from the printing head so that the ejecting amount of ink may be controlled so that the amount of ink ejected in Nmax main scannings is larger than that in the main scanning of Nmax-1th time or prior thereto, even if data items denoting the amount of ink for each pixel are the same as each other.

2. The printer according to claim 1,
wherein the printing head control unit controls the printing head so that a recording density of ink which is printed on the printing medium in the Nmax-th main scanning is increased compared to the main scanning of Nmax-1th time or prior thereto, even if data items denoting the amount of ink for each pixel are the same as each other.

3. The printer according to claim 1,
wherein the printing head control unit controls the printing head so that a size of the ink droplets which are ejected from the plurality of nozzles in the Nmax-th main scanning is larger than that in the Nmax-1th main scanning or prior thereto, even if data items denoting the amount of ink for each pixel are the same as each other.

4. A method of controlling a printer which includes a printing head in which a plurality of nozzles is formed, the method comprising:
moving the printing head in a predetermined direction, and causing the printing head to execute main scanning in which ink is ejected from the plurality of nozzles, and sub-scanning in which the printing head is moved in a direction perpendicular to the predetermined direction;
printing another line in Nth main scanning between lines which are printed in the main scanning of N-1th (N is a natural number of 2 or more), or prior thereto, and printing a unit of printing which is configured by a plurality of lines in Nmax main scannings (Nmax is the maximum value of N); and
controlling an amount of ink ejected from the printing head so that the amount of ink ejected in Nmax main scannings is larger than that in the main scanning of Nmax-1th time and prior thereto, even if data items denoting the amount of ink for each pixel are the same as each other.
